(19) United States
(12) Patent Application Publication
(10) Pub. No.: US 2014/0225876 A1
(43) Pub. Date: Aug. 14, 2014

(54) DISPLAY APPARATUS, DRIVING CHIP AND ERROR MESSAGE TRANSMISSION METHOD THEREOF

(71) Applicant: Novatek Microelectronics Corp., Hsinchu (TW)

(72) Inventors: Chih-Chao Yang, Hsinchu City (TW); Wei-Ying Tu, Hsinchu City (TW); Feng-Jung Kuo, Hsinchu County (TW)

(73) Assignee: Novatek Microelectronics Corp., Hsinchu (TW)

(21) Appl. No.: 13/948,177

(22) Filed: Jul. 23, 2013

(30) Foreign Application Priority Data
Feb. 8, 2013 (TW) 102105160

(51) Int. Cl. G09G 5/00

(52) U.S. Cl. CPC G09G 5/006
USPC 345/204

(57) ABSTRACT

A display apparatus, a driving chip, and an error message transmission method are provided. The driving chip is coupled to a system end to drive a display panel. The driving chip includes a display data receiving interface and an error detector. The display data receiving interface receives a display data stream from the system end. The error detector is coupled to the display data receiving interface and detects at least one error message generated when the display data receiving interface receives the display data stream. The driving chip has a plurality of output pins, and the driving chip transmits the error message to the system end through at least one idle pin among the output pins.

### CROSS-REFERENCE TO RELATED APPLICATION

This application claims the priority benefit of Taiwan application serial no. 102105160, filed on Feb. 8, 2013. The entirety of the above-mentioned patent application is hereby incorporated by reference herein and made a part of this specification.

### BACKGROUND OF THE INVENTION

1. Field of the Invention

The invention relates to a driving chip of a display apparatus; more particularly, the invention relates to an apparatus and a method for a driving chip to transmit an error message to a system end.

2. Description of Related Art

In order to allow a display apparatus to display images with high definition, transmission of display data through a high-speed transmission interface has become a mainstream trend. According to the conventional display technology, a mobile industry processor interface (MIPI) often serves as a transmission interface of a display data stream.

Once the process of transmitting the display data stream through the MIPI starts, it is rather difficult to terminate said process. Besides, given that a data stream transmission error occurs in the high-speed data transmission process, the system end that transmits the display data stream cannot be informed of the data stream transmission error immediately. Thereby, the error may not be instantly rectified by informing the system end of further transmitting the correct display data stream; moreover, the reason why the error occurs cannot be effectively analyzed, and this problem cannot be efficiently resolved.

In addition, according to the conventional technical scheme, if it is intended to transmit the error message back to the system end, the system end is required to terminate the transmission of the image sequence data stream and then receive the error message through the MIPI. That is, in order to rectify the error, the display apparatus cannot be used for a while, which causes inconvenience to users of the display apparatus.

### SUMMARY OF THE INVENTION

The invention is directed to a driving chip for driving a display panel and capable of transmitting an error message in the driving chip to a system end immediately.

The invention is directed to a display apparatus in which a driving chip is able to transmit an error message in the driving chip to a system end immediately.

The invention is directed to an error message transmission method of a driving chip of a display apparatus. Here, the error message in the driving chip may be effectively and immediately transmitted to a system end.

In an embodiment of the invention, a driving chip is provided, and the driving chip connects a system end to drive a display panel. The driving chip includes a display data receiving interface and an error detector. The display data receiving interface receives a display data stream from the system end. The error detector is coupled to the display data receiving interface and detects at least one error message generated when the display data receiving interface receives the display data stream. The driving chip has a plurality of output pins, and the driving chip transmits the error message to the system end through at least one idle pin among the output pins.

In an embodiment of the invention, a display apparatus that includes a system end, a display panel, and a driving chip is provided. The driving chip is coupled to the system end and the display panel. The driving chip includes a display data receiving interface and an error detector. The display data receiving interface receives a display data stream from the system end. The error detector is coupled to the display data receiving interface. The error detector detects at least one error message generated when the display data receiving interface receives the display data stream. Here, the driving chip has a plurality of output pins, and the error detector transmits the error message to the system end through at least one idle pin among the output pins.

In an embodiment of the invention, an error message transmission method of a driving chip of a display apparatus is provided, and the error message transmission method includes: receiving a display data stream from a system end; detecting at least one error message generated when the display data stream is received; transmitting the error message to the system end through at least one idle pin among a plurality of output pins of the driving chip.

In view of the above, the error detector immediately detects the error message generated when the display data receiving interface receives the display data stream from the system end, and the error message is transmitted to the system end through the idle pin on the driving chip. Thereby, the system end is able to timely obtain the error message from the driving chip and is not required to receive the error message after terminating the transmission of the display data stream within a certain time frame, such that the display apparatus may be operated in a more efficient manner.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a display apparatus 100 according to an embodiment of the invention.

FIG. 2 illustrates a waveform of an error data stream ERRS according to an embodiment of the invention.

FIG. 3A to FIG. 3C respectively illustrate waveforms of error data signals according to several embodiments of the invention.

FIG. 4 is a flowchart illustrating an error message transmission method according to an embodiment of the invention.

### DETAILED DESCRIPTION OF DISCLOSED EMBODIMENTS

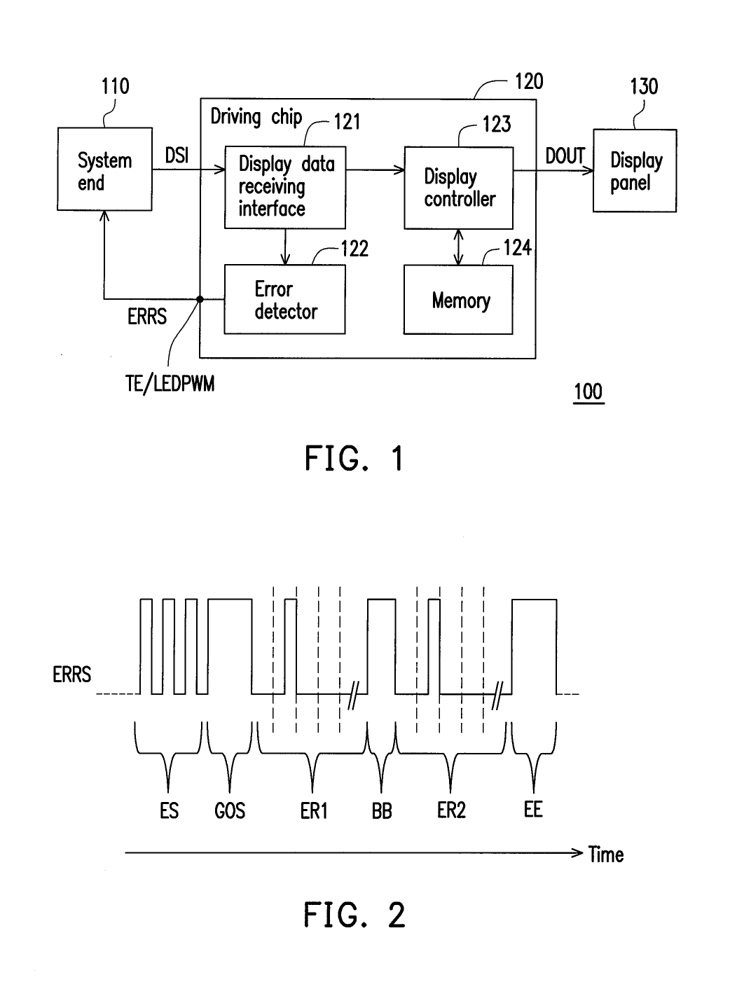

Please refer to FIG. 1 which is a schematic diagram illustrating a display apparatus 100 according to an embodiment of the invention. The display apparatus 100 includes a system end 110, a driving chip 120, and a display panel 130. The driving chip 120 is coupled to the system end 110 and the display panel 130. Besides, the driving chip 120 includes a display data receiving interface 121, an error detector 122, a display controller 123, and a memory 124. The display data receiving interface 121 is coupled to the system end 110 to receive a display data stream DSI from the system end 110. The error detector 122 is coupled to the display data receiving interface121 and detects at least one error message generated when the display data receiving interface 121 receives the display data stream DSI. Note that the error message may be generated because of the interference from the location of the display apparatus 100, the impedance mismatch of a transmission line between the system end 110 and the display data receiving interface 121, and/or the excessively fast data transmission speed of the display data stream DSI.

After the error detector 122 detects and obtains at least one error message generated when the display data receiving interface 121 receives the display data stream DSI, the error detector 122 transmits the detected error message back to the system end 110. Here, in the present embodiment, the error detector 122 may generate an error data stream ERRS according to the error message and transmit the error data stream ERRS to the system end 110 for analysis through a non-high-speed transmission channel.

In order not to increase the number of pins in the driving chip 120, the error detector 122 described in the present embodiment may transmit the error data stream ERRS through the idle pin among the output pins of the driving chip 120. Here, the idle pin may be a backlight control signal pin LEDPWM or a tearing effect (TE) signal pin TE, for instance.

In addition, during the transmission of the error data stream ERRS between the error detector 122 and the system end 110, any serial interface may be applied, such as an inter-integrated circuit (I2C) interface, a serial peripheral interface (SPI), and so forth.

The display controller 123 is coupled to the display data receiving interface 121 and receives a display data from the display data receiving interface 121. According to the received display data, the display controller 123 generates a plurality of driving signals DOUT to drive the display panel 130. The memory 124 is coupled to the display controller 123 and serves as a data buffer for the display controller 123. According to the requirements of the display controller 123, the memory 124 may act as a frame buffer and/or a line buffer. Since the way to use the memory as the frame buffer and/or the line buffer is known to people having ordinary skill in the pertinent art, no further explanation is provided hereinafter.

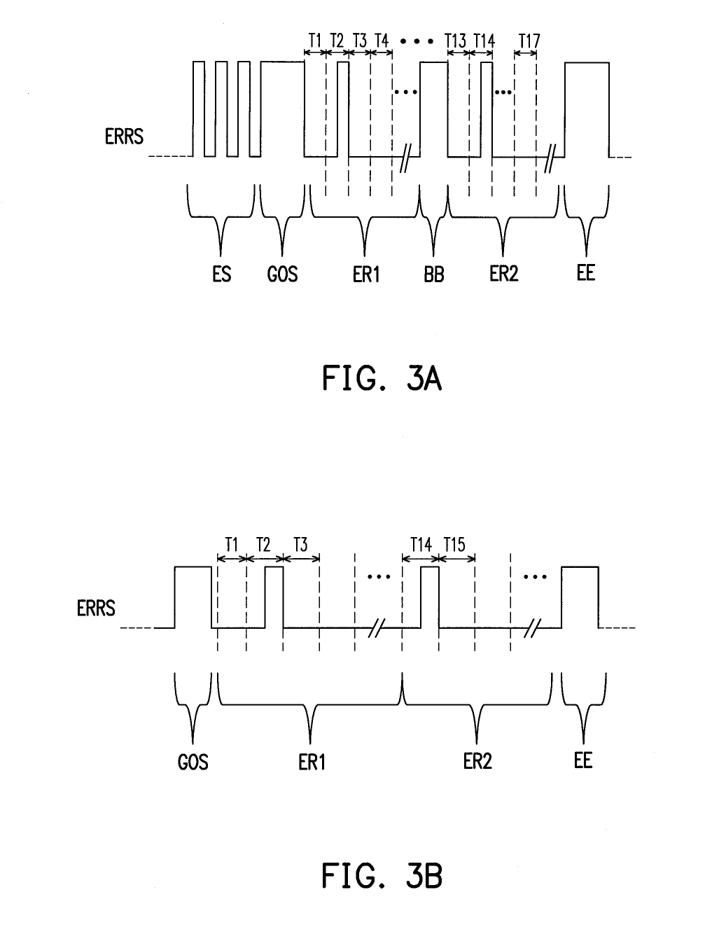

FIG. 2 illustrates a waveform of an error data stream ERRS according to an embodiment of the invention. Here, the error data stream ERRS sequentially includes an error start signal ES, error data signals ER1 and ER2, and an error end signal EE. The number of the error data signals ER1 and ER2 shown in FIG. 2 is merely exemplary, while the error start signal ES and the error end signal EE in the same error data stream ERRS may include one or more error data signals; that is, the number of the error data signals should not be construed as a limitation to the invention.

The error data stream ERRS may further include an error start protection signal GOS that is configured between the error start signal ES and the error data signal ER1 for separating these two signals and preventing these two signals from interrupting each other. It is also likely to configure a bit boundary signal BB between the error data signals ER1 and ER2, so as to separate the error data signals ER1 and ER2 from each other. That is, in one error data stream ERRS, the number of the bit boundary signals BB may be obtained by subtracting 1 from the number of the error data signals.

In the present embodiment, the error start signal ES is composed of plural pulses for informing the system end 110 of preparing to receive the error data signals ER1 and ER2 subsequently. The error start protection signal GOS may be a pulse signal that is continuously pulled up, so as to effectively separate the error start signal ES from the subsequent error data signal ER1. Here, the error start protection signal GOS is not required; given that the signal transmission quality is satisfactory, the error start protection signal GOS may be omitted. The bit boundary signal BB may also be a pulse signal that is continuously pulled up, so as to effectively separate the adjacent error data signals ER1 and ER2. Certainly, in case of the favorable signal transmission quality, the bit boundary signal BB may also be omitted.

The error end signal EE may also be a pulse signal that is continuously pulled up, so as to notify the termination of the transmission of the error data stream ERRS. To clearly define the difference among the error end signal EE, the bit boundary signal BB, and the error start protection signal GOS, the pull-up time of these signals may be defined differently, such that the system end 110 is able to learn whether the pull-up signal received by itself is the error end signal EE or the bit boundary signal BB (for separating the adjacent error data signals ER1 and ER2)/the error start protection signal GOS. Undoubtedly, the error end signal EE, the bit boundary signal BB, and the error start protection signal GOS may also be represented by different waveforms and should not be limited to the pull-up signals described in the present embodiment.

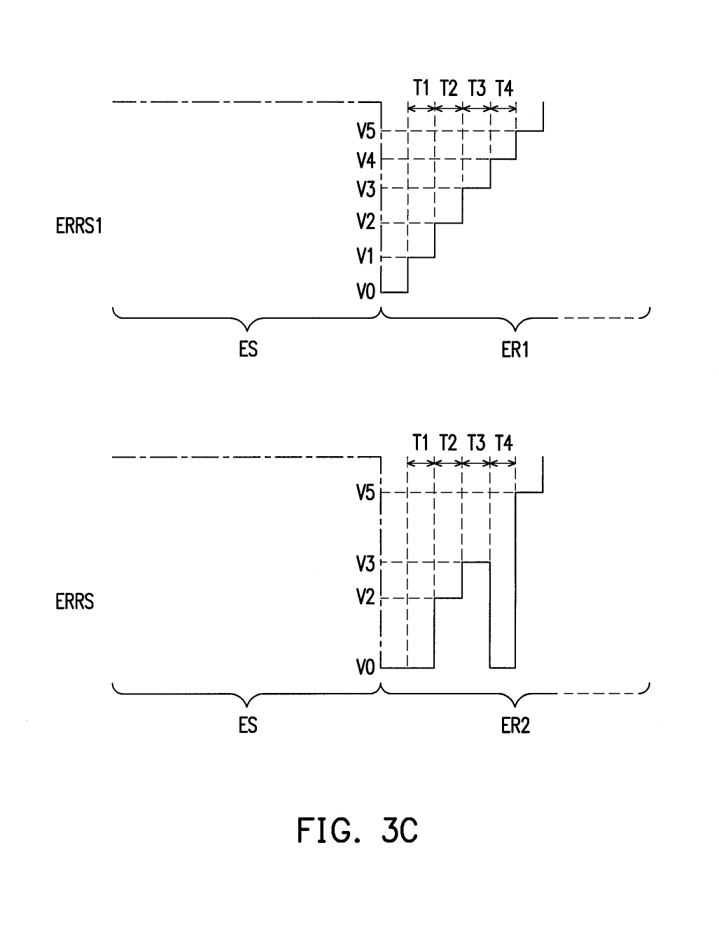

FIG. 3A to FIG. 3C respectively illustrate waveforms of error data signals according to several embodiments of the invention. In FIG. 3A, the error data stream ERRS is in the digital format, the error data signal ER1 is divided into a plurality of time periods T1 to T4, and the error data signal ER2 is divided into a plurality of time periods T13 to T17. These error data signals ER1 and ER2 are respectively defined to correspond to the errors that may occur when the display data receiving interface 121 receives the display data stream DSI. For instance, provided that errors 1 to 20 may occur when the display data receiving interface 121 receives the display data stream DSI, the error data signal ER1 may be divided into 10 time periods respectively corresponding to the errors 1 to 10, and the error data signal ER2 may be divided into 10 time periods respectively corresponding to the errors 11 to 20. When the display data receiving interface 121 receives the display data stream DSI, the errors 2 and 14 occur; thus, the voltage in the time period T2 of the error data signal ER1 corresponding to the error 2 is pulled up to be equal to a specific voltage (e.g., a logic high voltage), and the voltage in the time period T14 of the error data signal ER2 corresponding to the error 14 is also pulled up to be equal to the logic high voltage. On the other hand, the errors 1, 3 to 13, and 15-20 do not occur, and thus the voltage in the time periods T1, T3 to T13, and T15 to T20 of the error data signals ER1 and ER2 stays to be a logic low voltage (e.g., at 0 volt).

In FIG. 3B, the bit boundary signal BB is not required for separating the error data signals ER1 and ER2 from each other. Similarly, provided that errors 1 to 20 may occur when the display data receiving interface 121 receives the display data stream DSI, the error data signal ER1 may be divided into 10 time periods respectively corresponding to the errors 20 to 11, and the error data signal ER2 may be divided into 10 time periods respectively corresponding to the errors 10 to 1. As shown in FIG. 3B, the errors 19 and 7 may occur when the display data receiving interface 121 receives the display data stream DSI.

In FIG. 3C, the error data stream is in the analog format. The error data signal ER1 of the error data stream ERRS 1 indicates that no error occurs, such that voltages V1 to V5 of the error data signal ER1 gradually increase in a stepwise manner during the consecutive time periods T1 to T4. By contrast, in the error data signal ER2 of the error data stream ERRS2, the voltages in the time periods T1 and T4 are pulled to be equal to a certain voltage (i.e., the voltage V0). If the time periods T1 to T4 respectively correspond to errors 1 to 4, the error data signal ER2 indicates that the errors 1 and 4 occur.

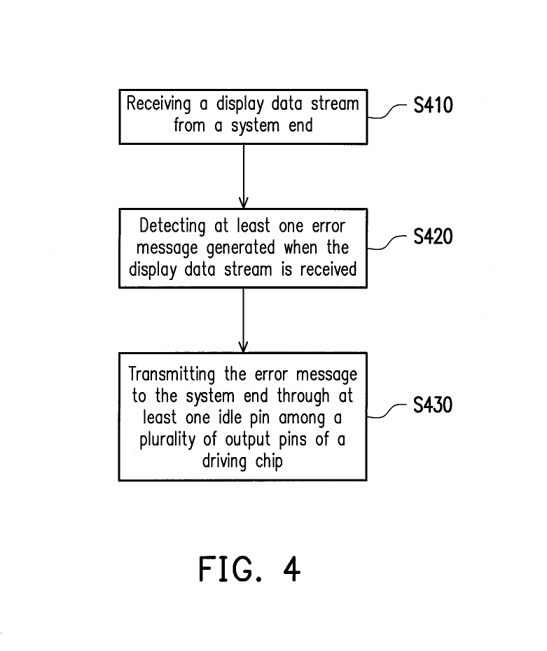

FIG. 4 is a flowchart illustrating an error message transmission method according to an embodiment of the invention. In step S410, the driving chip receives a display data stream from a system end; in step S420, the step of detecting at least one error message generated when the display data stream is received is simultaneously performed; in step S430, the error message is transmitted to the system end through at least one idle pin among the output pins of the driving chip. The detailed steps of the error message transmission method in the embodiment are elaborated in above embodiments and thus will not be further provided hereinafter.

To sum up, in an embodiment of the invention, the error detector is applied to detect the error message generated when the display data receiving interface receives the display data stream, and the error message is transmitted to the system end through the idle pin of the driving chip. Thereby, notwithstanding the absence of significant amount of hardware instruments, the error message may be transmitted back to the system end by means of the existing pins of the driving chip while the display data stream is continuously transmitted. Since the error message is effectively and immediately transmitted to the system end, the system end is able to timely analyze the transmission status of the display data stream and rectify the error, and therefore the performance of the display apparatus may be improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving chip connecting a system end to drive a display panel and comprising:
a display data receiving interface receiving a display data stream from the system end; and
an error detector coupled to the display data receiving interface, the error detector detecting at least one error message generated when the display data receiving interface receives the display data stream,
wherein the driving chip has a plurality of output pins, and the error detector transmits the at least one error message to the system end through at least one idle pin among the output pins.

2. The driving chip as recited in claim 1, wherein the error detector generates an error data stream according to the at least one error message, the error data stream sequentially comprises an error start signal, N error data signals, and an error end signal, and N is a positive integer.

3. The driving chip as recited in claim 2, wherein the error data stream further comprises:
an error start protection signal generated after the error start signal and before the error data signals.

4. The driving chip as recited in claim 2, wherein the error data stream further comprises:
(N−1) bit boundary signals generated among the error data signals.

5. The driving chip as recited in claim 1, wherein the error data stream is in a digital format or in an analog format.

6. The driving chip as recited in claim 2, wherein the error detector divides each of the error data signals into a plurality of consecutive time periods, and the error detector equalizes a voltage in at least one of the time periods of each of the error data signals with a specific voltage according to the at least one error message.

7. The driving chip as recited in claim 1, wherein the at least one idle pin is a backlight control signal pin or a tearing effect signal pin.

8. The driving chip as recited in claim 1, further comprising:
a display controller coupled to the display data receiving interface, the data controller receiving the display data stream and according to the display data stream generating a plurality of driving signals to drive the display panel.

9. The driving chip as recited in claim 8, further comprising:
a memory coupled to the display controller, the memory acting as a data buffer.

10. A display apparatus comprising:
a system end;
a display panel; and
a driving chip coupled to the system end and the display panel, the driving chip comprising:
a display data receiving interface receiving a display data stream from the system end; and
an error detector coupled to the display data receiving interface, the error detector detecting at least one error message generated when the display data receiving interface receives the display data stream,
wherein the driving chip has a plurality of output pins, and the error detector transmits the at least one error message to the system end through at least one idle pin among the output pins.

11. The display apparatus as recited in claim 10, wherein the error detector generates an error data stream according to the at least one error message, the error data stream sequentially comprises an error start signal, N error data signals, and an error end signal, and N is a positive integer.

12. The display apparatus as recited in claim 11, wherein the error data stream further comprises:
an error start protection signal generated after the error start signal and before the error data signals.

13. The display apparatus as recited in claim 11, wherein the error data stream further comprises:
(N−1) bit boundary signals generated among the error data signals.

14. The display apparatus as recited in claim 10, wherein the error data stream is in a digital format or in an analog format.

15. The display apparatus as recited in claim 10, wherein the error detector divides each of the error data signals into a plurality of consecutive time periods, and the error detector equalizes a voltage in at least one of the time periods of each of the error data signals with a specific voltage according to the at least one error message.

16. The display apparatus as recited in claim 9, wherein the at least one idle pin is a backlight control signal pin or a tearing effect signal pin.

17. An error message transmission method of a driving chip of a display apparatus, comprising:
receiving a display data stream from a system end;
detecting at least one error message generated when the display data stream is received; and
transmitting the at least one error message to the system end through at least one idle pin among a plurality of output pins of the driving chip.

18. The error message transmission method as recited in claim 17, further comprising:
simultaneously transmitting the at least one error message and receiving the display data stream.

19. The error message transmission method as recited in claim 17, further comprising:
generating an error data stream according to the at least one error message, wherein the error data stream sequentially comprises an error start signal, N error data signals, and an error end signal, and N is a positive integer.

20. The error message transmission method as recited in claim 19, wherein the step of generating the error data stream according to the at least one error message further comprises:
generating an error start protection signal after the error start signal and before the error data signals.

21. The error message transmission method as recited in claim 20, wherein the step of generating the error data stream according to the at least one error message further comprises:
generating (N−1) bit boundary signals among the error data signals.

22. The error message transmission method as recited in claim 19, wherein the step of generating the error data stream according to the at least one error message further comprises:
dividing each of the error data signals into a plurality of consecutive time periods; and
equalizing a voltage in at least one of the time periods of each of the error data signals with a specific voltage according to the at least one error message.
